(19) United States
(12) Patent Application Publication
(10) Pub. No.: US 2023/0277015 A1
(43) Pub. Date: Sep. 7, 2023

(54) Towel with integrated bottle opener

(71) Applicant: Adam W. Duncan, Apex, NC (US)

(72) Inventor: Adam W. Duncan, Apex, NC (US)

(21) Appl. No.: 17/685,589

(22) Filed: Mar. 3, 2022

(51) Int. Cl. A47K 10/02; B67B 7/16

(52) U.S. Cl. CPC A47K 10/02; B67B 7/16

(57) ABSTRACT

A towel according to the present invention that has an integrated bottle opener.

### TECHNICAL FIELD

The present application relates bottle openers, more particularly a towel with a bottle opener integrated into it.

### BACKGROUND

Regular bottle openers are normally small and can be easily misplaced or forgotten. Towels are great tools for cleaning, laying on and drying but can't assist in opening beverages. Presently there is no solution to integrate the two objects to create a more useful tool.

### SUMMARY

The present invention seeks to provide a solution to this problem by providing a tool that has a base design of a towel and integrates a bottle opener This would allow bartenders and beach goers alike to have one tool for multiple jobs.

### BRIEF DESCRIPTION OF THE DRAWINGS

FIG. 1 shows one embodiment of the towel with integrated bottle opener.

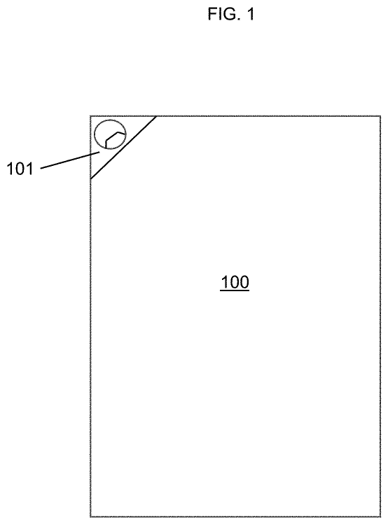

### DETAILED DESCRIPTION

The bottle opener 101 will be integrated into a towel 100. The bottle opener can be mechanically attached to the towel by the sewing, bolting, buttoning, riveting, tethering, gluing or molding.

The opener could also be held in by means of an integral pocket feature permanently attached to the towel 100 that can allow for removal and reinsertion of said opener. This would prove advantageous for washing and drying the towel and opener separately.

The opener 101 can be easily operated with one hand on the opener and one hand on the bottle. Having the bottle opener secured to the absorbent towel allows the person to easily clean any spills and dry their hands.

What is claimed:

1. A towel comprising; a bottle opener integrally attached there to.
